(19) United States
(12) Patent Application Publication
(10) Pub. No.: US 2024/0073997 A1
(43) Pub. Date: Feb. 29, 2024

(54) COMMUNICATION CONTROL METHOD, BASE STATION, AND USER EQUIPMENT

(71) Applicant: KYOCERA Corporation, Kyoto (JP)

(72) Inventors: Masato FUJISHIRO, Yokohama-shi (JP); Henry CHANG, San Diego, CA (US); Mitsutaka HATA, Yokohama-shi (JP)

(73) Assignee: KYOCERA Corporation, Kyoto (JP)

(21) Appl. No.: 18/505,510

(22) Filed: Nov. 9, 2023

Related U.S. Application Data
(63) Continuation of application No. PCT/JP2022/019817, filed on May 10, 2022.
(60) Provisional application No. 63/186,525, filed on May 10, 2021.

(51) Int. Cl. H04W 76/40; H04W 68/02; H04W 74/08

(52) U.S. Cl. CPC H04W 76/40; H04W 68/02; H04W 74/0833

(57) ABSTRACT

In a first aspect, a communication control method is a communication control method used in a mobile communication system for providing a multicast broadcast service (MBS). The communication control method includes: transmitting, by a base station to a group including a plurality of user equipments, a group notification indicating activation of a multicast session corresponding to the group; and receiving, by the base station, a random access preamble transmitted from the user equipment in response to reception of the group notification. The transmitting of the group notification includes transmitting, by the base station, the group notification to each of a plurality of subgroups at different timings, the plurality of subgroups being obtained by dividing the group.

### RELATED APPLICATIONS

The present application is a continuation based on PCT Application No. PCT/JP2022/019817, filed on May 10, 2022, which claims the benefit of U.S. Provisional Patent Application No. 63/186,525 filed on May 10, 2021. The content of which is incorporated by reference herein in their entirety.

### TECHNICAL FIELD

The present disclosure relates to a communication control method, a base station, and a user equipment used in a mobile communication system.

### BACKGROUND OF INVENTION

In recent years, a mobile communication system of the fifth generation (5G) has attracted attention. New Radio (NR), which is a Radio Access Technology (RAT) of the 5G system, has features such as high speed, large capacity, high reliability, and low latency compared to Long Term Evolution (LTE), which is a fourth-generation radio access technology.

### CITATION LIST

### Non-Patent Literature

Non-Patent Document 1: 3GPP Technical Specification “3GPP TS 38.300 V16.3.0 (2020-09)”

### SUMMARY

In a first aspect, a communication control method is a communication control method used in a mobile communication system for providing a multicast broadcast service (MBS). The communication control method includes: transmitting, by a base station to a group including a plurality of user equipments, a group notification indicating activation of a multicast session corresponding to the group; and receiving, by the base station, a random access preamble transmitted from the user equipment in response to reception of the group notification. The transmitting of the group notification includes transmitting, by the base station, the group notification to each of a plurality of subgroups at different timings, the plurality of subgroups being obtained by dividing the group.

In a second aspect, a communication control method is a communication control method used in a mobile communication system for providing a multicast broadcast service (MBS). The communication control method includes: receiving, by a user equipment in an RRC idle state or an RRC inactive state, a group notification from a base station, the group notification indicating that an MBS session corresponding to a group to which the user equipment belongs is activated; determining, by the user equipment, a transmission timing of transmitting a random access preamble to the base station, after receiving the group notification; and transmitting the random access preamble at the determined transmission timing. The determining of the transmission timing includes determining the transmission timing to be different from transmission timings of other user equipments belonging to the group.

In a third aspect, a base station includes a processor that performs the communication control method according to the first aspect.

In a fourth aspect, a user equipment includes a processor that performs the communication control method according to the second aspect.

### BRIEF DESCRIPTION OF THE DRAWINGS

FIG. 1 is a diagram illustrating a configuration of a mobile communication system according to an embodiment.

FIG. 2 is a diagram illustrating a configuration of a UE (user equipment) according to an embodiment.

FIG. 3 is a diagram illustrating a configuration of a gNB (base station) according to an embodiment.

FIG. 4 is a diagram illustrating a configuration of a protocol stack of a radio interface of a user plane handling data.

FIG. 5 is a diagram illustrating a configuration of a protocol stack of a radio interface of a control plane handling signaling (control signal).

FIG. 6 is a diagram illustrating a correspondence relationship between a downlink Logical channel and a downlink Transport channel according to an embodiment.

FIG. 7 is a diagram illustrating a delivery method of IBS data according to an embodiment.

FIG. 8 is a diagram illustrating a split MBS bearer according to an embodiment.

FIG. 9 is a diagram illustrating a multicast session join process in the mobile communication system according to an embodiment.

FIG. 10 is a diagram illustrating a process related to a priority of a UE 100 in the mobile communication system according to an embodiment.

FIG. 11 is a diagram illustrating a basic sequence of an operation of the mobile communication system according to an embodiment.

FIG. 12 is a diagram illustrating a pattern of operation initiated by a gNB 200 in the mobile communication system according to an embodiment.

FIG. 13 is a diagram illustrating a first pattern of operation initiated by the UE 100 in the mobile communication system according to an embodiment.

FIG. 14 is a diagram illustrating a second pattern of operation initiated by the UE 100 in the mobile communication system according to an embodiment.

FIG. 15 is a diagram illustrating a third pattern of operation initiated by the UE 100 in the mobile communication system according to an embodiment.

FIG. 16 is a diagram illustrating a fourth pattern of operation initiated by the UE 100 in the mobile communication system according to an embodiment.

FIG. 17 is a diagram illustrating a fifth pattern of operation initiated by the UE 100 in the mobile communication system according to an embodiment.

FIG. 18 is a diagram illustrating an existing paging record list.

FIG. 19 is a diagram illustrating a new record list.

### DESCRIPTION OF EMBODIMENTS

Introduction of multicast broadcast services to the 5G system (NR) has been under study. NR multicast broadcast services are desired to provide enhanced services compared to LTE multicast broadcast services.

In view of this, the present disclosure provides a communication control method and a user equipment for implementing enhanced multicast broadcast services.

A mobile communication system according to an embodiment is described with reference to the drawings. In the description of the drawings, the same or similar parts are denoted by the same or similar reference signs.

Configuration of Mobile Communication System

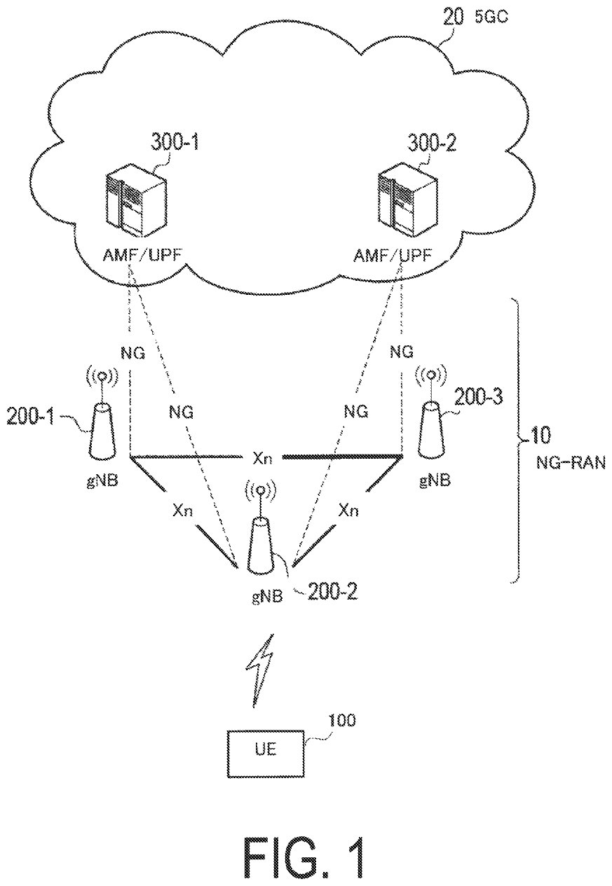

First, a configuration of a mobile communication system according to an embodiment is described. FIG. 1 is a diagram illustrating a configuration of the mobile communication system according to an embodiment. This mobile communication system complies with the 5th Generation System (5GS) of the 3GPP standard. The description below takes the 5GS as an example, but Long Term Evolution (LTE) system may be at least partially applied to the mobile communication system. A sixth generation (6G) system may be at least partially applied to the mobile communication system.

As illustrated in FIG. 1, the mobile communication system includes a User Equipment (UE) 100, a 5G radio access network (Next Generation Radio Access Network (NG-RAN)) 10, and a 5G Core Network (5GC) 20.

The UE 100 is a mobile wireless communication apparatus. The UE 100 may be any apparatus as long as the UE 100 is used by a user. Examples of the UE 100 include a mobile phone terminal (including a smartphone) and/or a tablet terminal, a notebook PC, a communication module (including a communication card or a chipset), a sensor or an apparatus provided on a sensor, a vehicle or an apparatus provided on a vehicle (Vehicle UE), and a flying object or an apparatus provided on a flying object (Aerial UE).

The NG-RAN 10 includes base stations (referred to as “gNBs” in the 5G system) 200. The gNBs 200 are interconnected via an Xn interface which is an inter-base station interface. Each gNB 200 manages one or more cells. The gNB 200 performs wireless communication with the UE 100 that has established a connection to the cell of the gNB 200. The gNB 200 has a radio resource management (RRM) function, a function of routing user data (hereinafter simply referred to as “data”), a measurement control function for mobility control and scheduling, and the like. The “cell” is used as a term representing a minimum unit of a wireless communication area. The “cell” is also used as a term representing a function or a resource for performing wireless communication with the UE 100. One cell belongs to one carrier frequency.

Note that the gNB can be connected to an Evolved Packet Core (EPC) corresponding to a core network of LTE. An LTE base station can also be connected to the 5GC. The LTE base station and the gNB can be connected via an inter-base station interface.

The 5GC 20 includes an Access and Mobility Management Function (AMF) and a User Plane Function (UPF) 300. The AMF performs various types of mobility controls and the like for the UE 100. The AMF manages mobility of the UE 100 by communicating with the UE 100 by using Non-Access Stratum (NAS) signaling. The UPF controls data transfer. The AMF and UPF are connected to the gNB 200 via an NG interface which is an interface between a base station and the core network.

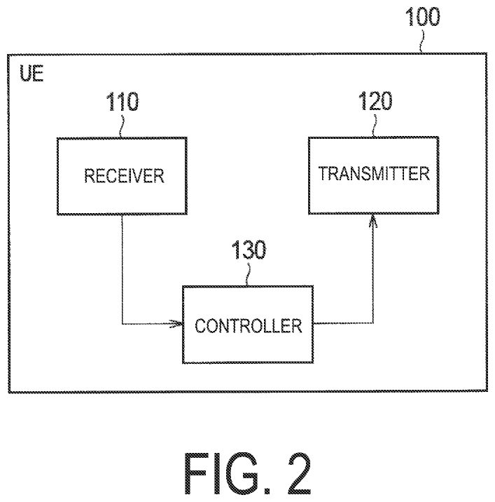

FIG. 2 is a diagram illustrating a configuration of a UE 100 (user equipment) according to an embodiment.

As illustrated in FIG. 2, the UE 100 includes a receiver 110, a transmitter 120, and a controller 130.

The receiver 110 performs various types of reception under control of the controller 130. The receiver 110 includes an antenna and a reception device. The reception device converts a radio signal received through the antenna into a baseband signal (a reception signal) and outputs the resulting signal to the controller 130.

The transmitter 120 performs various types of transmission under control of the controller 130. The transmitter 120 includes an antenna and a transmission device. The transmission device converts a baseband signal (a transmission signal) output by the controller 130 into a radio signal and transmits the resulting signal through the antenna.

The controller 130 performs various types of control in the UE 100. The controller 130 includes at least one processor and at least one memory. The memory stores a program to be executed by the processor and information to be used for processing by the processor. The processor may include a baseband processor and a Central Processing Unit (CPU). The baseband processor performs modulation and demodulation, coding and decoding, and the like of a baseband signal. The CPU executes the program stored in the memory to thereby perform various types of processing.

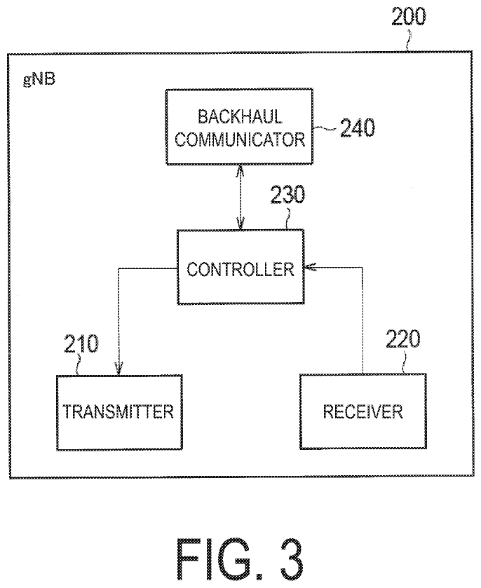

FIG. 3 is a diagram illustrating a configuration of the gNB 200 (base station) according to an embodiment.

As illustrated in FIG. 3, the gNB 200 includes a transmitter 210, a receiver 220, a controller 230, and a backhaul communicator 240.

The transmitter 210 performs various types of transmission under control of the controller 230. The transmitter 210 includes an antenna and a transmission device. The transmission device converts a baseband signal (a transmission signal) output by the controller 230 into a radio signal and transmits the resulting signal through the antenna.

The receiver 220 performs various types of reception under control of the controller 230. The receiver 220 includes an antenna and a reception device. The reception device converts a radio signal received through the antenna into a baseband signal (a reception signal) and outputs the resulting signal to the controller 230.

The controller 230 performs various types of controls for the gNB 200. The controller 230 includes at least one processor and at least one memory. The memory stores a program to be executed by the processor and information to be used for processing by the processor. The processor may include a baseband processor and a CPU. The baseband processor performs modulation and demodulation, coding and decoding, and the like of a baseband signal. The CPU executes the program stored in the memory to thereby perform various types of processing.

The backhaul communicator 240 is connected to a neighboring base station via the inter-base station interface. The backhaul communicator 240 is connected to the AMF/UPF 300 via the interface between a base station and the core network. Note that the gNB may include a Central Unit (CU) and a Distributed Unit (DU) (i.e., functions are divided), and both units may be connected via an F1 interface.

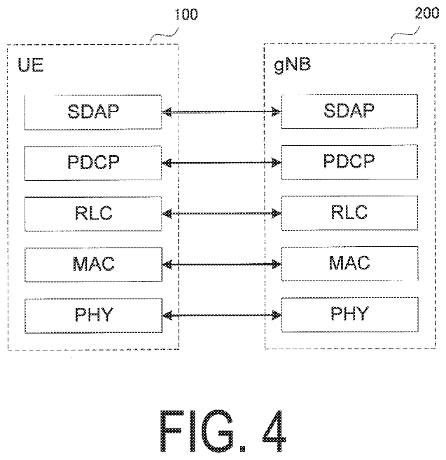

FIG. 4 is a diagram illustrating a configuration of a protocol stack of a radio interface of a user plane handling data.

As illustrated in FIG. 4, a radio interface protocol of the user plane includes a physical (PHY) layer, a Medium Access Control (MAC) layer, a Radio Link Control (RLC) layer, a Packet Data Convergence Protocol (PDCP) layer, and a Service Data Adaptation Protocol (SDAP) layer.

The PHY layer performs coding and decoding, modulation and demodulation, antenna mapping and demapping, and resource mapping and demapping. Data and control information are transmitted between the PHY layer of the UE 100 and the PHY layer of the gNB 200 via a physical channel.

The MAC layer performs priority control of data, retransmission processing through hybrid ARQ (HARQ: Hybrid Automatic Repeat reQuest), a random access procedure, and the like. Data and control information are transmitted between the MAC layer of the UE 100 and the MAC layer of the gNB 200 via a transport channel. The MAC layer of the gNB 200 includes a scheduler. The scheduler determines transport formats (transport block sizes, Modulation and Coding Schemes (MCSs)) in the uplink and the downlink and resource blocks to be allocated to the UE 100.

The RLC layer transmits data to the RLC layer on the reception side by using functions of the MAC layer and the PHY layer. Data and control information are transmitted between the RLC layer of the UE 100 and the RLC layer of the gNB 200 via a logical channel.

The PDCP layer performs header compression and decompression, and encryption and decryption.

The SDAP layer performs mapping between an IP flow as the unit of Quality of Service (QoS) control performed by a core network and a radio bearer as the unit of QoS control performed by an Access Stratum (AS). Note that, when the RAN is connected to the EPC, the SDAP need not be provided.

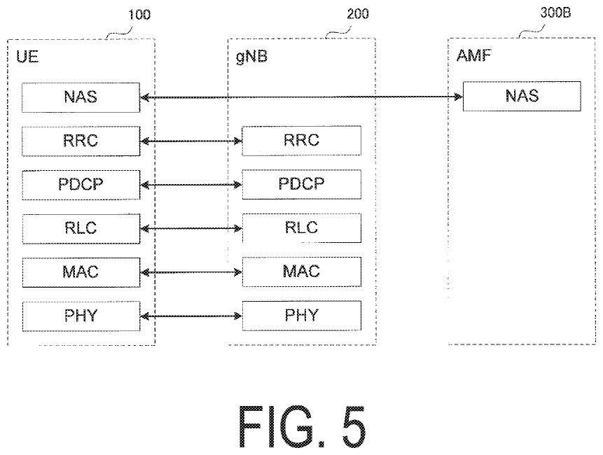

FIG. 5 is a diagram illustrating a configuration of a protocol stack of a radio interface of a control plane handling signaling (a control signal).

As illustrated in FIG. 5, the protocol stack of the radio interface of the control plane includes a Radio Resource Control (RRC) layer and a Non-Access Stratum (NAS) layer instead of the SDAP layer illustrated in FIG. 4.

RRC signaling for various configurations is transmitted between the RRC layer of the UE 100 and the RRC layer of the gNB 200. The RRC layer controls a logical channel, a transport channel, and a physical channel according to establishment, re-establishment, and release of a radio bearer. When a connection between the RRC of the UE 100 and the RRC of the gNB 200 (RRC connection) exists, the UE 100 is in an RRC connected state. When a connection between the RRC of the UE 100 and the RRC of the gNB 200 (RRC connection) does not exist, the UE 100 is in an RRC idle state. When the connection between the RRC of the UE 100 and the RRC of the gNB 200 is suspended, the UE 100 is in an RRC inactive state.

The NAS layer which is positioned upper than the RRC layer performs session management, mobility management, and the like. NAS signaling is transmitted between the NAS layer of the UE 100 and the NAS layer of an AMF 300B.

Note that the UE 100 includes an application layer other than the protocol of the radio interface.

MBS

An MBS according to an embodiment is described. The MBS is a service in which the NG-RAN 10 can provide broadcast or multicast, i.e., Point To Multipoint (PTM) data transmission to the UE 100. The MBS may be referred to as the Multimedia Broadcast and Multicast Service (MBMS). Note that use cases (service types) of the MBS include public safety communication, mission critical communication, Vehicle to Everything (V2X) communication, IPv4 or IPv6 multicast delivery, Internet Protocol TeleVision (IPTV), group call, and software delivery.

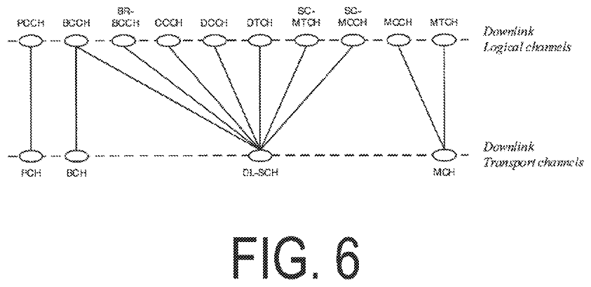

MBS Transmission in LTE includes two schemes, i.e., a Multicast Broadcast Single Frequency Network (MBSFN) transmission and Single Cell Point To Multipoint (SC-PTM) transmission. FIG. 6 is a diagram illustrating a correspondence relationship between a downlink Logical channel and a downlink Transport channel according to an embodiment.

As illustrated in FIG. 6, the logical channels used for MBSFN transmission are a Multicast Traffic Channel (MTCH) and a Multicast Control Channel (MCCH), and the transport channel used for MBSFN transmission is a Multicast Channel (MCH). The MBSFN transmission is designed primarily for multi-cell transmission, and in an MBSFN area including a plurality of cells, each cell synchronously transmits the same signal (the same data) in the same MBSFN subframe.

The logical channels used for SC-PTM transmission are a Single Cell Multicast Traffic Channel (SC-MTCH) and a Single Cell Multicast Control Channel (SC-MCCH). The transport channel used for SC-PTM transmission is a Downlink Shared Channel (DL-SCH). The SC-PTM transmission is primarily designed for single-cell transmission and corresponds to broadcast or multicast data transmission on a cell-by-cell basis. The physical channels used for SC-PTM transmission are a Physical Downlink Control Channel (PDCCH) and a Physical Downlink Shared Channel (PDSCH) and enable dynamic resource allocation.

Although an example will be mainly described below in which the MBS is provided using a scheme same as, and/or similar to, the SC-PTM transmission scheme, the MBS may be provided using the MBSFN transmission scheme. An example will be mainly described in which the MBS is provided using multicast. Accordingly, the MBS may be interpreted as multicast. Note that the MBS may be provided using broadcast.

The MBS data refers to data provided by the MBS. The MBS control channel refers to the MCCH or the SC-MCCH. The MBS traffic channel refers to the MTCH or the SC-MTCH. Note that the MBS data may be transmitted in unicast. The MBS data may be referred to as MBS packets or MBS traffic.

The network can provide different MBS services for respective MBS sessions. The MBS session is identified by Temporary Mobile Group Identity (TMGI) and/or a session identifier (session ID), and at least one of these identifiers is referred to as an MBS session identifier. Such an MBS session identifier may be referred to as an MBS service identifier or a multicast group identifier. The MBS session identifier may be a G-RNTI described later.

The MBS session includes a multicast session and a broadcast session.

The multicast session is a session for delivering a multicast service. The multicast service provides a service to a group of UEs 100 joining a multicast session for an application requiring highly reliable QoS. The multicast session is available to the UE 100 in the RRC connected state. The multicast session may be available to the UE 100 in the RRC inactive state. Hereinafter, the MBS data transmitted in multicast (MBS data belonging to a multicast session) is referred to as multicast data.

The broadcast session is a session for delivering a broadcast service. The broadcast service provides a service to every UE 100 within a particular service area. The broadcast session is available to the UE 100 in all RRC states (RRC idle state, RRC inactive state, and RRC connected state).

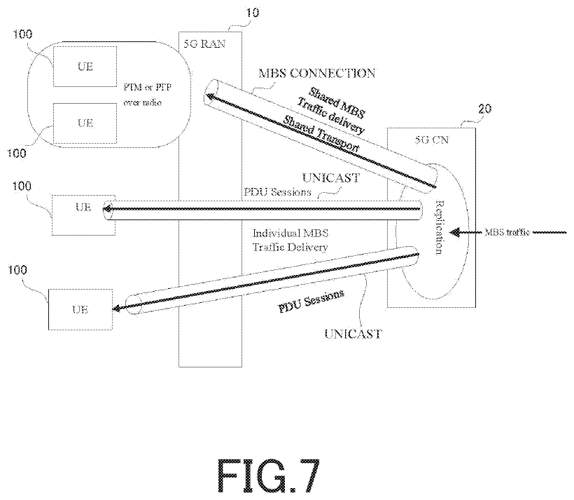

FIG. 7 is a diagram illustrating a delivery method of the MBS data according to an embodiment.

As illustrated in FIG. 7, the MBS data (MBS Traffic) is delivered from a single data source (application service provider) to a plurality of UEs. The 5G CN (5GC) 20, which is a 5G core network, receives the MBS data from the application service provider and performs Replication of the MBS data to deliver the resultant.

From the perspective of the 5GC 20, two delivery methods are possible: shared MBS data delivery (Shared MBS Traffic delivery) and individual MBS data delivery (Individual MBS Traffic delivery).

In the shared MBS data delivery, a connection is established between the NG-RAN 10 that is a 5G radio access network (5G RAN) and the 5GC 20 to deliver the MBS data from the 5GC 20 to the NG-RAN 10. Such a connection (a tunnel) is hereinafter referred to as an “MBS connection”.

The MBS connection may be referred to as a Shared MBS Traffic delivery connection or a shared transport. The MBS connection terminates at the NG-RAN 10 (i.e., the gNB 200). The MBS connection may correspond to an MBS session on a one-to-one basis.

The gNB 200 selects a transmission scheme either of Point-to-Point (PTP: unicast) or Point-to-Multipoint (PTM: multicast or broadcast) at the discretion of the gNB 200 and transmits the MBS data to the UE 100 through the selected transmission scheme.

On the other hand, in the individual MBS data delivery, a unicast session is established between the NG-RAN 10 and the UE 100 to individually deliver the MBS data from the 5GC 20 to the UE 100. Such unicast may be referred to as a PDU Session. The unicast (PDU session) terminates at the UE 100.

Split MBS Bearer

A split MBS bearer according to an embodiment is described.

The gNB 200 may configure an MBS bearer split into a PTP communication path and a PTM communication path (hereinafter referred to as a “split MBS bearer” as appropriate) for the UE 100. This allows the gNB 200 to dynamically switch the transmission of the MBS data to the UE 100 between the PTP (PTP communication path) and the PTM (PTM communication path). The gNB 200 may perform duplication transmission of the same MBS data using both the PTP (PTP communication path) and the PTM (PTM communication path) to enhance reliability.

A predetermined layer terminating the split is the MAC layer (HARQ), the RLC layer, the PDCP layer, or the SDAP layer. Although an example in which the predetermined layer terminating the split is the PDCP layer will be mainly described below, the predetermined layer may be the MAC layer (HARQ), the RLC layer, or the SDAP layer.

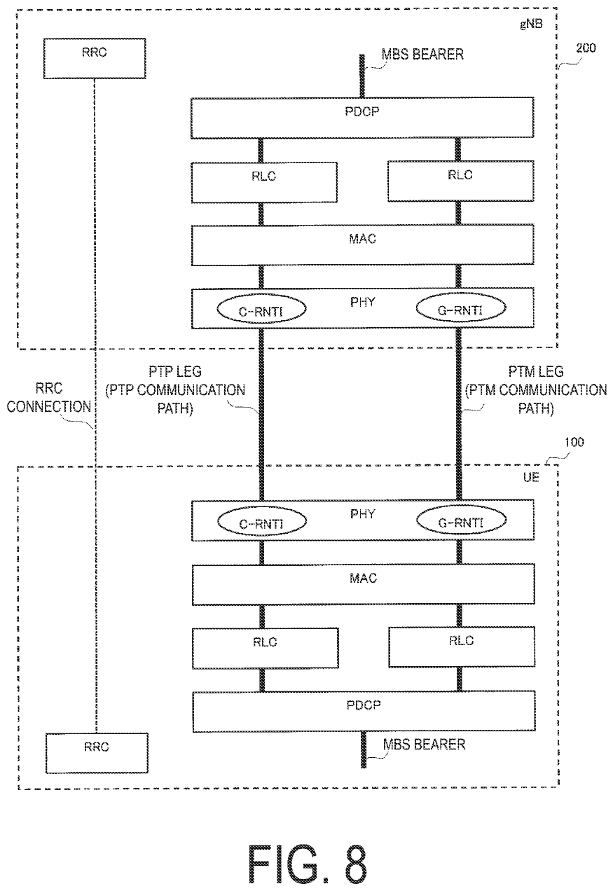

FIG. 8 is a diagram illustrating the split MBS bearer according to an embodiment. Hereinafter, the PTP communication path is referred to as a PTP leg, and the PTM communication path is referred to as a PTM leg. A functional unit corresponding to each layer is referred to as an entity. In the PTM leg, the MBS data is transmitted in multicast.

As illustrated in FIG. 8, each of the PDCP entity of the gNB 200 and the PDCP entity of the UE 100 splits an MBS bearer, which is a bearer (data radio bearer) used for the MBS, into a PTP leg and a PTM leg. Note that the PDCP entity is provided for each bearer.

Each of the gNB 200 and the UE 100 includes two RLC entities provided for the respective legs, one MAC entity, and one PHY entity. The PHY entity may be provided per leg. Note that, in a Dual Connectivity in which the UE 100 communicates with two gNBs 200, the UE 100 may include two MAC entities.

The PHY entity transmits and receives data of the PTP leg using a cell RNTI (Cell Radio Network Temporary Identifier (C-RNTI)) that is allocated to the UE 100 on a one-to-one basis. The PHY entity transmits and receives data of the PTM leg using a group RNTI (Group Radio Network Temporary Identifier (G-RNTI)) allocated to the MBS session on a one-to-one basis. The C-RNTI is different for each UE 100, but the G-RNTI is an RNTI common to a plurality of UEs 100 receiving one MBS session.

In order to perform PTM transmission of the MBS data (multicast or broadcast) from the gNB 200 to the UE 100 using a PTM leg, a split MBS bearer needs to be configured for the UE 100 from the gNB 200 and the PTM leg needs to be activated. In other words, even if a split MBS bearer is configured for the UE 100, when a PTM leg is in a deactivation state, the gNB 200 cannot perform the PTM transmission of the MBS data using the PTM leg.

In order that the gNB 200 and the UE 100 perform PTP transmission of the MBS data (unicast) using a PTP leg, a split MBS bearer needs to be configured for the UE 100 from the gNB 200 and the PTP leg needs to be activated. In other words, even if a split MBS bearer is configured for the UE 100, when a PTP leg is in a deactivation state, the gNB 200 cannot perform the PTP transmission of the MBS data using the PTP leg.

When the PTM leg is in an activated state, the UE 100 monitors a Physical Downlink Control Channel (PDCCH) to which a G-RNTI associated with the MBS session is applied (i.e., performs blind decoding of the PDCCH using the G-RNTI). The UE 100 may monitor the PDCCH only at a scheduling occasion of the MBS session.

When the PTM leg is in a deactivated state, the UE 100 does not monitor a PDCCH to which a G-RNTI associated with the MBS session is applied (i.e., does not perform blind decoding of the PDCCH using the G-RNTI).

When the PTP leg is in an activated state, the ULE 100 monitors a PDCCH to which a C-RNTI is applied. When Discontinuous Reception (DRX) in the PTP leg is configured, the UE 100 monitors a PDCCH for a configured OnDuration period. When a cell (frequency) associated with the MBS session is specified, the UE 100 may monitor a PDCCH for the cell even when the cell is deactivated.

When the PTP leg is in a deactivated state, the UE 100 may monitor a PDCCH to which a C-RNTI is applied in preparation for normal unicast downlink transmission of other than the MBS data. Note that, when a cell (frequency) associated with an MBS session is specified, the UE 100 need not monitor a PDCCH for the MBS session.

Note that it is assumed that the above-described split MBS bearer is configured by use of an RRC message (for example, an RRC Reconfiguration message) transmitted by the RRC entity of the gNB 200 to the RRC entity of the UE 100.

Operation of Mobile Communication System Operations of a mobile communication system according to an embodiment will be described.

Hereinafter, assume mainly a case that a UE 100 in the RRC connected state receives MBS data (i.e., multicast data) transmitted from a gNB 200. Therefore, assume that the MBS session is a multicast session and the MBS session identifier is a multicast session identifier (for example, TMGI, Session ID, or G-RNTI). The multicast session is mapped to a PTM bearer (or Multicast Radio Bearer (MRB)). The PTM bearer includes a PTP (or PTP leg) and/or a PTM (or PTM leg). The MBS traffic channel (MTCH) is used for multicast data transmission from the gNB 200 to the UE 100.

Hereinafter, the gNB 200 and an AMF 300 may be collectively referred to as a “network apparatus” as appropriate. The AMF 300 is an example of a core network (CN) apparatus. The AMF 300 manages the multicast session in cooperation with a session management apparatus. The session management apparatus is another example of the CN apparatus.

Multicast Session Join Process

A multicast session join process in the mobile communication system according to an embodiment is described.

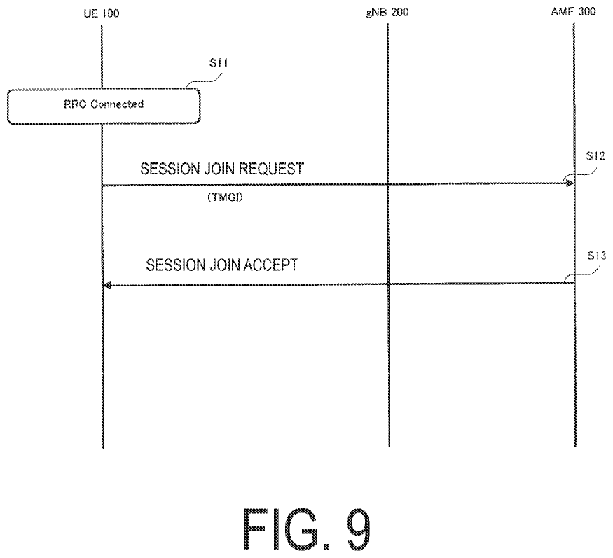

FIG. 9 is a diagram illustrating the multicast session join process in the mobile communication system according to an embodiment.

As illustrated in FIG. 9, in step S11, the UE 100 is in the RRC connected state. Assume that the UE 100 is interested in a multicast session (hereinafter referred to as a “target multicast session”). The phrase “being interested in a multicast session” means that an upper layer of the UE 100 requests or wants to receive the multicast session. The upper layer includes a NAS layer. The upper layer may further include an application.

In step S12, the UE 100 transmits a session join request message requesting to join in the target multicast session to the AMF 300. The session join request message includes a multicast session identifier (e.g., TMGI) identifying the target multicast session. The session join request message is a NAS message and is transmitted to the AMF 300 via the gNB 200.

In step S13, the AMF 300 transmits a session join accept message accepting the joining in the target multicast session to the UE 100. The session join accept message is a NAS message and is transmitted to the UE 100 via the gNB 200. This allows the UE 100 to join the target multicast session. The phrase “joining in the target multicast session” means that the UE 100 is registered on the CN apparatus as a member of a UE group (multicast group) that receives the multicast session. Note that the joining in a multicast session may be performed while the multicast session is in an activated state (during transmission). The joining in a multicast session may be performed in a deactivated state (during waiting for transmission start or transmission interruption).

After receiving the session join accept message, the UE 100 may transition to the RRC idle state or the RRC inactive state when the multicast session is in the deactivated state. That is, the gNB 200 transmits the RRC Release message to the UE 100 joining in the multicast session in the deactivated state. The identifier of the UE 100 registered on the CN apparatus and joining in the multicast session may be notified to the gNB 200 via the AMF 300.

Information indicating whether the multicast session is in the activated state or deactivated state may be notified from the AMF 300 to the gNB 200. For example, the information may be notified by a multicast session activation message (Multicast Session Activation) or a multicast session deactivation message (Multicast Session Deactivation).

Process Related to Priority of UE 100

A description is given of a process related to the priority of the UE 100 in the mobile communication system according to an embodiment. Here, the “priority of the UE 100” means an access priority of the UE 100 for a multicast session. For example, for a multicast session, a UE 100 with a higher priority may have priority over a UE 100 with a lower priority to access the gNB 200 providing the multicast session. For example, a UE 100 for public safety has a priority 3 (high-priority) and a UE 100 with a premium user contract has a priority 2 (medium-priority). Note that a general UE 100 may have a priority 1 (low-priority). The gNB 200 or the AMF 300 acquire the priority of the UE 100. The gNB 200 or the AMF 300 may use the acquired priority of the UE 100 in a UE group division process described below.

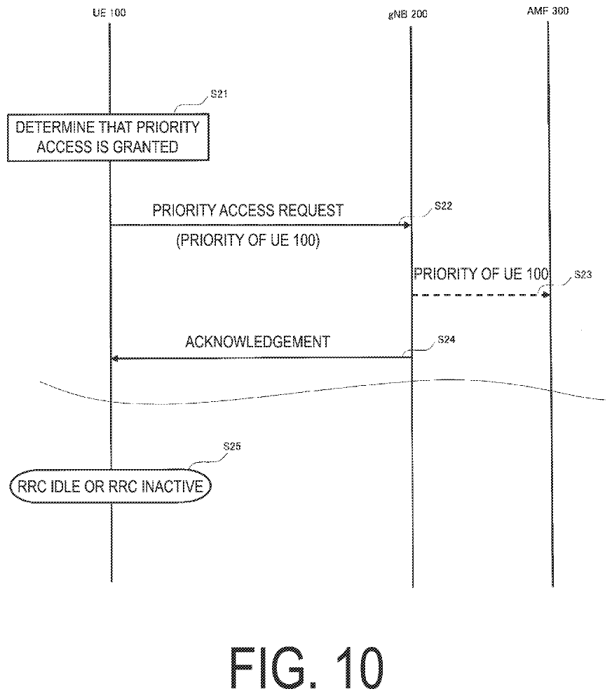

FIG. 10 is a diagram illustrating a process related to the priority of the UE 100 in the mobile communication system according to an embodiment.

As illustrated in FIG. 10, in step S21, the UE 100 determines whether a priority access is granted for a target multicast session (a multicast session the UE 100 joins or a multicast session the UE 100 is interested in). Specifically, the UE 100 determines that the priority access is granted when at least one of the following conditions is met. 1) The NAS entity of the UE 100 receives a notification of priority access permission from the AMF 300. 2) The priority access is permitted in the user contract of the UE 100 (for example, information indicating that priority access is permitted is written in a subscriber identity module (SIM) mounted in the UE 100. 3) An application requiring priority handling (for example, a public safety application) is being executed in the UE 100 application.

When the UE 100 determines that the priority access is granted, the UE 100 transmits a priority access request to request the priority access right from the gNB 200 in step S22. The gNB 200 receives the priority access request from the UE 100. The priority access request includes information indicating the priority of the UE 100 corresponding to the priority access of the UE 100. This allows the gNB 200 to acquire the priority of the UE 100. Note that the gNB 200 may regard a UE 100 that does not transmit a priority access request (i.e., a UE 100 to which the priority access is not granted) as the UE 100 having a low-priority. The gNB 200 may use the priority of the UE 100 in the UE group division process described below.

Here, the priority access request is transmitted by one of the following methods.
1) The UE 100 transmits the priority access request by using a “cause” information element in an RRC Setup Request message or an RRC Resume Request message the UE 100 transmits in transitioning to the connected state for the multicast session join process described above. For example, the UE 100 sets the priority of UE 100 equal to a value of the “cause” information element. Here, in order to distinguish from the priority for unicast communication, a “cause” information element for multicast (for example, “multicast priority access”) may be newly provided.
2) The UE 100 transmits the priority access request by using a specific physical random access channel (PRACH) resource in a random access preamble the UE 100 transmits in transitioning to the connected state for the multicast session join process described above. The specific PRACH resource may be configured from the gNB 200 via a common control channel (system information block, SIB) or an individual control channel (RRC Reconfiguration).
3) The UE 100 transmits the priority access request in a UE Assistance Information message or Msg 5. In this case, the UE 100 may transmit, in the UE Assistance Information message or Msg 5, the multicast session identifier of the multicast session for which the priority access is permitted.

The UE 100 may transmit the priority access request only when the target multicast session is in the deactivated state. Alternatively, the UE 100 may transmit the priority access request only when the multicast bearer is not configured by the RRC Reconfiguration message.

The gNB 200 may use the priority access request transmitted from the UE 100 for access restriction. That is, the gNB 200 permits an access from the UE 100 having a higher priority. Permitting the access may be any one of transmitting an acknowledgement (Msg 2) in response to receiving the random access preamble (Msg 1) and transmitting an acknowledgement (RRC Setup or RRC Resume) (Msg 4) in response to the RRC Setup Request or RRC Resume Request (Msg 3). The gNB 200 may reject an access from the UE 100. Rejecting the access may be any one of transmitting a negative acknowledgement in Msg 2 or transmitting no response in response to Msg 1, transmitting a Msg 4 negative acknowledgement or transmitting no response in response to Msg 3, and transmitting Msg 5 and the RRC Release thereafter.

The gNB 200 may transmit the information indicating the priority of the UE 100 to the AMF 300 in step S23. This allows the AMF 300 to acquire the priority of the UE 100. The AMF 300 may use the acquired priority of the UE 100 in the UE group division process described below.

In step S24, the gNB 200 transmits an acknowledgement to the UE 100 in response to the priority access request received in step S22.

In step S25, the UE 100 transitions to the RRC idle state or the RRC inactive state. The UE 100 may transition to the RRC idle state or the RRC inactive state when the multicast session is not activated within a certain period of time after receiving the acknowledgement. Alternatively, the gNB 200 may release the RRC connection (that is, transmit the RRC Release).

A description is given of an example in which the gNB 200 acquires the priority of the UE 100 from the AMF 300.

Firstly, the AMF 300 acquires the priority of the UE 100 for the multicast session from a Policy Control Function (PCF). The PCF is an apparatus managing contract information of the UE 100. For example, the PCF notifies the AMF 300 of the priority of the UE 100 for each TMGI from the contract information.

Secondly, the AMF 300 transmits the information indicating the priority of the UE 100 to the gNB 200. This allows the gNB 200 to acquire the priority of the UE 100. The AMF 300 transmits the information indicating the priority of the UE 100 to the gNB 200 by use of, for example, a UE context modification message which is a type of an NG-AP (Application protocol) message.

Basic Sequence of Operation of Mobile Communication System

A description is given of a basic sequence of the operation of the mobile communication system according to an embodiment.

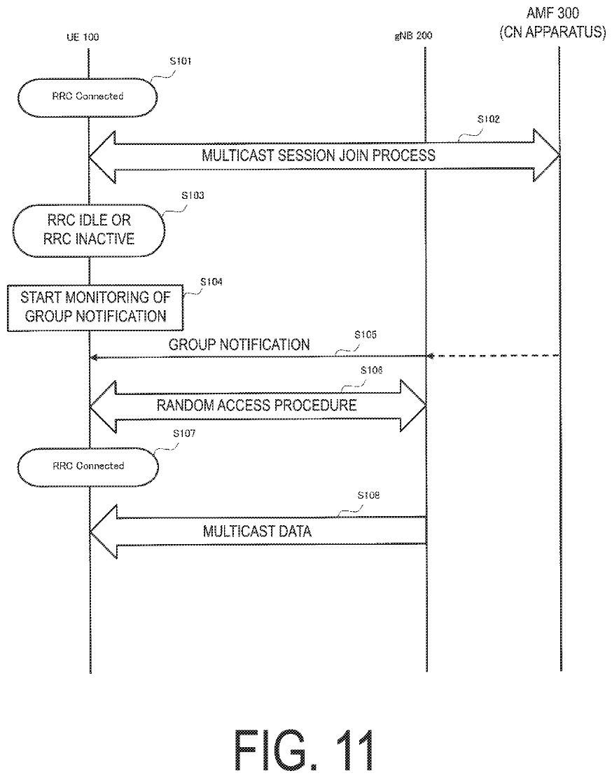

FIG. 11 is a diagram illustrating the basic sequence of the operation of the mobile communication system according to an embodiment.

As illustrated in FIG. 11, in step S101, the UE 100 is in the RRC connected state.

In step S102, the UE 100 (NAS entity) performs, on the network apparatus, the multicast session join process to join in the target multicast session.

In step S103, the UE 100 transitions to the RRC idle state or the RRC inactive state. Specifically, the UE 100 transitions to the RRC idle state or the RRC inactive state upon receiving the RRC Release message from the gNB 200. Prior to step S103, the UE 100 may transmit to the gNB 200 an RRC message (for example, UE Assistance Information message) including an information element prompting the UE 100 to transition to the RRC idle state or the RRC inactive state.

In step S104, the UE 100 starts monitoring of a group notification from the gNB 200. The group notification may be a paging message transmitted from the gNB 200. The group notification may also be a message transmitted on a multicast control channel (MCCH) from the gNB 200. When the group notification is a paging message, the UE 100 monitors the group notification on a paging occasion (PO) of a periodically configured paging frame (PF). When the group notification is a message transmitted on the MCCH, the UE 100 monitors the MCCH in accordance with information configuring a monitoring timing of the MCCH. The UE 100 may acquire the information from the SIB. The monitoring timing of the MCCH is periodically configured.

In step S105, the gNB 200 transmits a group notification addressed to a UE group including the UE 100. The gNB 200 may transmit a group notification (paging message) to the UE 100 in response to a paging request from the AMF 300. The gNB 200 may transmit a group notification (paging message or MCCH) to the UE 100 in response to receiving the multicast session activation message (Multicast Session Activation) from the AMF 300. The group notification may include any one or more of a multicast session identifier of the multicast session associated with the UE group, an identifier of each UE 100 belonging to the UE group, and a multicast session identifier associated with the identifier of the UE 100. The UE 100 having received the group notification including the multicast session identifier of the multicast session the UE 100 joins or is interested in or the identifier of the UE 100 can recognize that the target multicast session the UE 100 joins is activated. The phrase “the target multicast session is activated” may mean that the multicast data is started to be transmitted in the target multicast session. The phrase “the target multicast session is activated” may also mean that the multicast data is in a state of capable of being started to be transmitted in the target multicast session.

In step S106, the UE 100 performs the random access procedure on the gNB 200 to receive the target multicast session.

Specifically, firstly, the UE 100 transmits a random access preamble to the gNB 200. The random access preamble is transmitted via the Physical Random Access Channel (PRACH). The UE 100 may be configured with a plurality of PRACH transmission occasions that occur periodically. Such PRACH transmission occasions may be configured for the UE 100 by use of the SIB or RRC Release message transmitted by the gNB 200. Generally, the UE 100 transmits the random access preamble on a PRACH occasion that is available firstly after the timing of receiving the group notification (first PRACH occasion).

Secondly, the gNB 200 transmits a random access response (message 2 (Msg 2)) to the UE 100 in response to receiving the random access preamble from the UE 100.

Thirdly, the UE 100 transmits a message 3 (Msg 3) to the gNB 200 in response to receiving the random access response from the gNB 200. When the UE 100 is in the RRC idle state, the message 3 is an RRC Setup Request message. When the UE 100 is in the RRC inactive state, the message 3 is an RRC Resume Request message.

Fourthly, the gNB 200 transmits a message 4 (Msg 4) to the UE 100 in response to receiving the message 3 from UE 100. When the UE 100 is in the RRC idle state, the message 4 is an RRC Setup message. When the UE 100 is in the RRC inactive state, the message 4 is an RRC Resume message. After that, the UE 100 transitions to the RRC connected state.

Fifthly, the UE 100 transmits a message 5 (Msg 5) to the gNB 200 in response to receiving the message 4 (Msg 4). The message 5 is an RRC Setup Complete message or an RRC Resume Complete message.

Note that the UE 100 may perform a 2-step random access procedure. In this case, Msg 1 and Msg 3 are integrated into one message (Msg A), and Msg 2 and Msg 4 are integrated into one message (Msg B).

In step S107, the UE 100 transitions to the RRC connected state through the random access procedure.

In step S108, the UE 100 in the RRC connected state receives the multicast data of the target multicast session from the gNB 200. Prior to receiving the data, configuration for the target multicast session reception may be made for the UE 100 by the gNB 200. The configuration is an RRC Reconfiguration message including an MRB (multicast radio bearer) configuration, for example.

In such a basic sequence, when the number of UEs 100 (UEs 100 in the RRC idle state or the RRC inactive state) in the UE group (multicast group) is large, many UEs 100 simultaneously transmit the random access preambles to the gNB 200 in response to receiving the group notification. This causes a problem of overload of the PRACH. Due to such PRACH overloading, a PRACH collision frequently occurs, and access delay or inaccessibility of the UE 100 may occur.

Pattern of Operation Initiated by gNB 200

A description is given of a pattern of operation initiated by the gNB 200 in the mobile communication system according to an embodiment.

In a pattern of operation initiated by the gNB 200, the gNB 200 transmits, to a UE group, a group notification indicating activation of a multicast session corresponding to the UE group. In transmitting the group notification, the gNB 200 transmits the group notification to each of a plurality of subgroups at a different timing, the plurality of subgroups obtained by dividing the UE group. This allows the transmission timing of the group notification to be different for each of the subgroups. Therefore, the transmission timing of the random access preamble is dispersed among the subgroups. Thus, the PRACH overloading is suppressed.

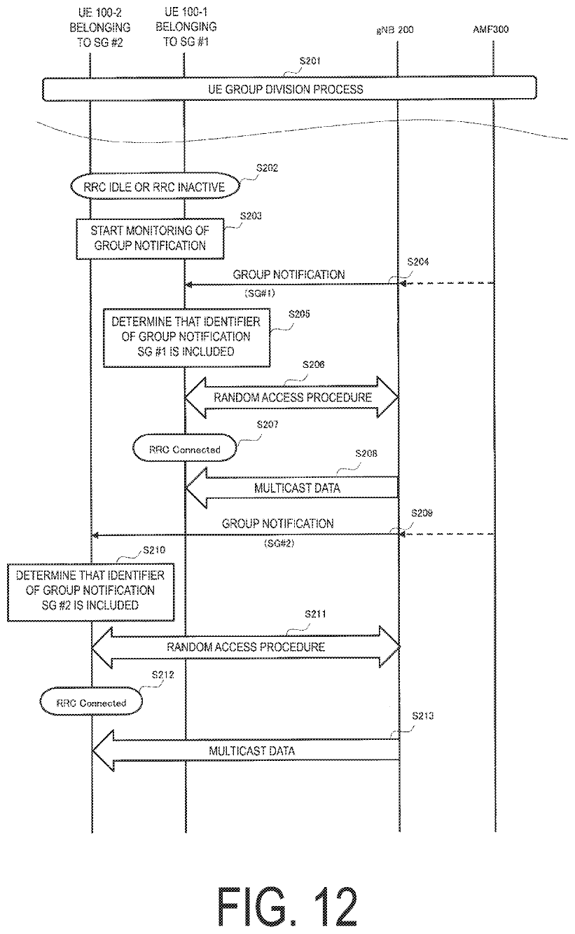

FIG. 12 is a diagram illustrating a pattern of operation initiated by the gNB 200 in the mobile communication system according to an embodiment. Here, a description is given mainly of differences from the basic sequence described above.

As illustrated in FIG. 12, in step S201, a UE group division process is performed. An operation subject of the UE group division process may be the gNB 200. The operation subject of the UE group division process may be the AMF 300.

A description is given of an example in which the operation subject of the UE group division process is the gNB 200.

Firstly, the gNB 200 divides a UE group corresponding to a multicast session into a plurality of subgroups. For example, the gNB 200 divides the UE group such that the number of UEs 100 belonging to each subgroup does not exceed an upper limit value (X). The gNB 200 may determine the upper limit value depending on an amount of PRACH resources available in the cell the gNB 200 itself manages. For example, when the PRACH is not overloaded even though X UEs 100 simultaneously transmit the random access preambles to the gNB 200, the gNB 200 sets the upper limit value equal to X. When the gNB 200 acquires the priority of the UE 100 in the process related to the priority of the UE 100 described above, the gNB 200 may divide the UE group based on the priority of the UE 100. For example, the gNB 200 divides the UE group so that the UEs 100 having the same priority belong to the same subgroup. The gNB 200 desirably sets the upper limit value for the subgroup of the UE 100 having a higher priority to be lower than the upper limit values for other subgroups.

Secondly, the gNB 200 allocates a subgroup identifier to each of the plurality of subgroups obtained by dividing the UE group. The gNB 200 may further allocate an RNTI (subgroup RNTI. SG-RNTI) as well as the subgroup identifier.

Thirdly, the gNB 200 notifies the UE 100 belonging to a subgroup identified by a subgroup identifier of the subgroup identifier. The subgroup identifier is notified from the gNB 200 to the UE 100, for example, in the multicast session join process. For example, the gNB 200 notifies the UE 100 of a join accept message corresponding to a multicast session together with a subgroup identifier corresponding to the multicast session. The gNB 200 may notify the UE 100 of the subgroup identifier through the RRC Reconfiguration message or the RRC Release message. The gNB 200 may notify the UE 100 of the SG-RNTI corresponding to the subgroup identifier together with the subgroup identifier. The SG-RNTI is used for decoding of the PDSCH corresponding to the group notification. The gNB 200 may notify the UE 100 of the multicast session identifier corresponding to the subgroup identifier together with the subgroup identifier.

The operation subject of the UE group division process may be the AMF 300. In this case, the AMF 300 notifies the gNB 200 of the identifier of each subgroup and the identifier of each UE 100 belonging to the subgroup.

In the following description, assume that a UE group corresponding to a multicast session is divided into two subgroups. The two subgroups include a subgroup (first subgroup) identified by a subgroup identifier “SG #1” and a subgroup (second subgroup) identified by a subgroup identifier “SG #2”. Each subgroup includes at least one UE 100. In FIG. 12, a UE 100 belonging to the first subgroup is indicated by “UE 100-1”, and a UE 100 belonging to the second subgroup is indicated by “UE 100-2”. In addition, assume that the UE 100 belonging to the first subgroup has a high-priority and the UE 100 belonging to the second subgroup has a low-priority.

In step S202, the UEs 100 (UE 100-1 and UE 100-2) transition to the RRC idle state or the RRC inactive state.

In step S203, the UEs 100 (UE 100-1 and UE 100-2) start monitoring of a group notification from the gNB 200. When each UE 100 is notified of the SG-RNTI in step S201, the UE 100 may monitor the group notification by using the SG-RNTI. This allows the UE 100 to omit decoding of a PDSCH corresponding to a group notification not addressed to the subgroup to which the UE 100 itself belongs.

In step S204, the gNB 200 transmits a group notification addressed to the first subgroup. The group notification includes the subgroup identifier “SG #1”. Such a group notification may include a multicast session identifier (e.g., TMGI) of a multicast session to be activated. When the subgroup identifier is unique among multicast sessions, such a group notification need not include the multicast session identifier.

Here, since the UE 100 belonging to the first subgroup has the high-priority, the gNB 200 transmits the group notification addressed to the first subgroup prior to the second subgroup (the subgroup to which the UE 100 having the low-priority belongs). This allows the UE 100 with the high-priority to have priority over the UE 100 with the low-priority to access the gNB 200.

In step S205, the UE 100-1 determines whether the group notification received in step S204 includes the subgroup identifier “SG #1” notified to the UE 100-1 itself (i.e., the subgroup identifier “SG #1” notified in step S201). The UE 100-1, when determining that the group notification includes “SG #1”, performs the random access procedure with the gNB 200 in step S206. Note that, in this case, the UE 100 may notify the gNB 200 that the UE 100 has the high-priority by using the “cause” information element in the RRC Setup Request message or the RRC Resume Request message.

Operations in steps S206 to S208 are the same as and/or similar to the operations in steps S106 to S108.

In step S209, the gNB 200 transmits a group notification addressed to the second subgroup. The group notification includes the subgroup identifier “SG #2”.

In step S210, the UE 100-2 determines whether the group notification received in step S209 includes the subgroup identifier “SG #2” notified in step S201. The UE 100-2, when determining that the group notification includes “SG #2”, performs the random access procedure with the gNB 200 in step S211. Here, the UE 100-2, when determining that “SG #2” is not included in the group notification, does not perform the random access procedure and continues monitoring of the group notification. When the group notification includes the multicast session identifier of the multicast session the UE 100-2 itself joins and the group notification does not include the subgroup identifier “SG #2” notified to the UE 100-2 itself, the UE 100-2 does not perform the random access procedure and continues monitoring of the group notification. That is, even though the UE 100-2, due to receiving the group notification, grasps the activation of the multicast session the UE 100-2 itself joins, when the UE 100-2 is not a subject to be notified of the group notification, the UE 100-2 does not perform the random access procedure and continues monitoring of the group notification.

Operations in steps S211 to S213 are the same as and/or similar to the operations in steps S106 to S108.

In the pattern of operation initiated by the gNB 200, the gNB 200 may notify the UE 100-1 having the high-priority of the activation of the multicast session by use of a unicast paging message instead of the group notification. Such a unicast paging message includes the multicast session identifier (e.g., TMGI) of the multicast session to be activated. The UE 100-1, in response to receiving such a unicast paging message, performs the random access procedure on the gNB 200, and transitions to the RRC connected state to receive the multicast data.

The gNB 200 transmits the unicast paging message before the group notification. When the UE 100 to be notified is in the RRC idle state, the unicast paging message is transmitted in a CN (Core Network) paging. When the UE 100 to be notified is in the RRC inactive state, the unicast paging message is transmitted in an RAN (Radio Access Network) paging.

The CN paging is a paging initiated by the AMF 300. The unicast paging message transmitted in the CN paging includes a 5G-S temporary mobile subscriber identity (5G-S-TNSI) allocated to the UE 100 from the AMF 300 as an identifier of the UE 100 to be paged.

The RAN paging is a paging initiated by the gNB 200. The unicast paging message transmitted in the RAN paging includes an Inactive-RNTI (I-RNTI) allocated to the UE 100 from the gNB 200 as an identifier of the UE 100 to be paged.

Pattern of Operation Initiated by UE 100

A description is given of a pattern of operation initiated by the UE 100 in the mobile communication system according to an embodiment.

In a pattern of operation initiated by the UE 100, the UE 100 in the RRC idle state or the RRC inactive state receives a group notification from the gNB 200, the group notification indicating that a multicast session corresponding to a UE group to which the UE 100 belongs is activated. After receiving the group notification, the UE 100 determines a transmission timing to transmit a random access preamble to the gNB 200. The UE 100 transmits the random access preamble at the determined timing. In determining the transmission timing, the UE 100 determines the transmission timing different from transmission timings for other UEs 100 belonging to the UE group. As a result, the transmission timing of the random access preamble is dispersed among the UEs 100 belonging to the UE group. Thus, the PRACH overloading is suppressed.

First Pattern of Operation Initiated by UE 100

A description is given of a first pattern of operation initiated by the UE 100 in the mobile communication system according to an embodiment.

In the first pattern of operation initiated by the UE 100, the UE 100 in the RRC idle state or the RRC inactive state receives a paging message from the gNB 200 as the group notification. After receiving the paging message, the UE 100 determines a transmission timing to transmit a random access preamble to the gNB 200. The UE 100 transmits the random access preamble at the determined timing. In determining the transmission timing, the UE 100 determines a PRACH transmission occasion corresponding to a paging reception occasion on which the paging message is received as the transmission timing when a predetermined condition is met, and determines a PRACH transmission occasion corresponding to a next paging reception occasion after the paging reception occasion on which the paging message is received as the transmission timing when a predetermined condition is not met. This allows the transmission timing of the random access preamble to be dispersed among the UEs 100 depending on the predetermined condition. Thus, the PRACH overloading is suppressed.

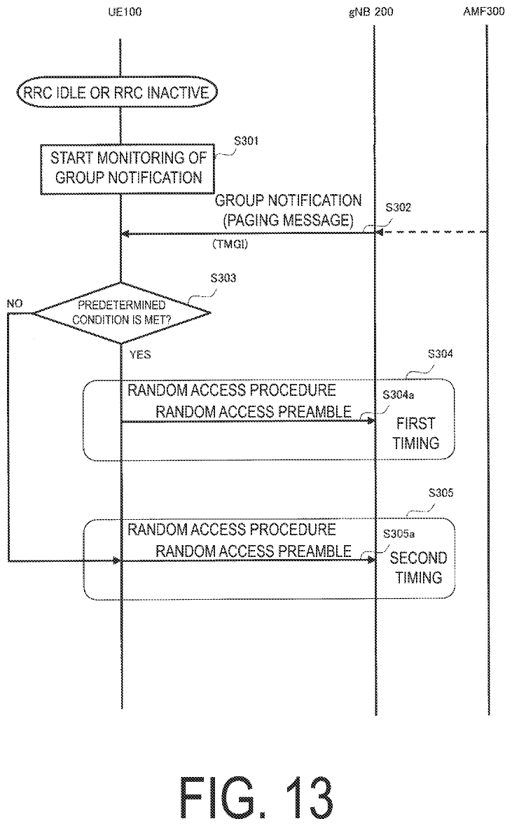

FIG. 13 is a diagram illustrating the first pattern of operation initiated by the UE 100 in the mobile communication system according to an embodiment. Description is given mainly of differences from the patterns of operation described above.

In an initial state of FIG. 13, the UE 100 has already performed the multicast session join process and is in the RRC idle state or the RRC inactive state. In the first pattern, assume that the group notification is a paging message.

As illustrated in FIG. 13, in step S301, the UE 100 starts monitoring of the group notification (paging message) from the gNB 200. The UE 100 monitors the group notification (paging messages) on a PO of a periodically configured PF.

In step S302, the UE 100 receives the group notification (paging message) from the gNB 200. Here, the group notification (paging message) includes the identifier (e.g., TMGI) of the multicast session the UE 100 joins.

In step S303, the UE 100 determines whether a predetermined condition is met. When determining that the predetermined condition is met (step S303: YES), the UE 100 starts the random access procedure at the first timing in step S304. To be more specific, the UE 100 transmits the random access preamble at the first timing (step S304a). On the other hand, when determining that the predetermined condition is not met (step S303: NO), the UE 100 starts the random access procedure at the second timing later than the first timing in step S305. To be more specific, the UE 100 transmits the random access preamble at the second timing (step S305a). In other words, when determining that the predetermined condition is not met, the UE 100 suspends transmission of the random access preamble, and then, transmits the suspended random access preamble when the second timing arrives.

A description is given of the “first timing,” “second timing,” and “predetermined condition” described above.

Examples of the first timing include the PRACH transmission occasion corresponding to the PO that the group notification is received on. Here, the “PRACH transmission occasion corresponding to the PO” means differently depending on whether an association between the PO and the PRACH transmission occasion is configured for the gNB 200.

When the gNB 200 does not configure the association between the PO and the PRACH transmission occasion, the “PRACH transmission occasion corresponding to the PO” is a PRACH occasion available firstly after the PO.

When the gNB 200 configures the association between the PO and the PRACH transmission occasion, the “PRACH transmission occasion corresponding to the PO” is a PRACH transmission occasion associated with the PO, the PRACH transmission occasion indicated in information configuring the association. The association between the PO and the PRACH transmission occasion may be 1:1,1:N, or N:1. For example, N PRACH transmission occasions are associated with one PO (when adopting 1:N). When adopting 1:N, the UE 100 may select one of N PRACH transmission occasions at random. The information configuring the association may be notified to the UE 100 by use of the SIB. The information configuring the association may be notified to the UE 100 through the RRC Release message causing the UE 100 to transition to the RRC idle/inactive states.

Examples of the second timing include the PRACH transmission occasion corresponding to the next PO after the PO that the group notification is received on. That is, in this case, the UE 100 considers receiving the group notification on the next PO, and transmits the random access preamble on the PRACH transmission occasion corresponding to the next PO. Since the PO is determined based on the identifier of the UE 100 (5G-S-TMSI), such a second timing is dispersed among the UEs 100 belonging to the UE group.

Note that the first timing and the second timing may be autonomously determined in the UE 100. The second timing is sufficient to be a timing after the first timing.

The phrase the “predetermined condition is met” refers to at least one of the following: 1) The UE 100 is configured with an extended DRX. 2) The UE 100 is configured with a time window for paging reception, and the UE 100 receives the group notification on the last paging occasion in the time window. 3) The UE 100 is configured with a timer.

As for 1), since a time interval between the POs when the UE 100 is configured with an extended DRX is longer than when a normal DRX is configured, the UE 100 transmits the random access preamble at the first timing to reduce a delay in multicast session reception.

As for 2), the UE 100 is configured with a time window containing a plurality of POs from the gNB 200. The time window is configured with parameters (time window parameters) such as a start position (starting point), a window time length, and a window period. The time window parameter is notified to the UE from the gNB by use of the SIB, the RRC Release message, or the like. The UE 100 monitors the paging basically during the time window. After the end of a time window, the UE 100 does not monitor the paging until the next time window arrives. The UE 100, when receiving the group notification on the last PO in the time window, transmits the random access preamble at the first timing. In this case, for the UE 100, since the next PO occurs after the window period expires, the UE 100 transmits the random access preamble at the first timing to reduce the delay in the multicast session reception. Note that the UE 100 transmits the random access preamble at the first timing also when the UE 100 receives the group notification outside the time window (that is, when receives the group notification after the end of the time window because the UE 100 wakes up late).

As for 3), the UE 100 is configured, from the gNB 200, with a timer to delay the transmission timing of the random access preamble. The UE 100 starts the timer in response to receiving the group notification, and transmits the random access preamble on the PRACH transmission occasion (second timing) corresponding to the first PO after the timer expires. Such a timer may be configured individually for the UE 100 in the UE group corresponding to the multicast session. This allows the transmission timing of the random access preamble to be dispersed among the UEs 100.

The UE 100 transitions to the RRC connected state through the random access procedure performed in step S304 or step S305 to receive the multicast data.

Second Pattern of Operation Initiated by UE 100

A description is given of a second pattern of operation initiated by the UE 100 in the mobile communication system according to an embodiment.

In the second pattern of operation initiated by the UE 100, the UE 100 starts the timer in response to receiving the group notification. The UE 100 determines the PRACH transmission occasion after the timer expires as the transmission timing of the random access preamble. The timer is individually configured for the UE 100. This allows the transmission timing of the random access preamble to be dispersed among the UEs 100.

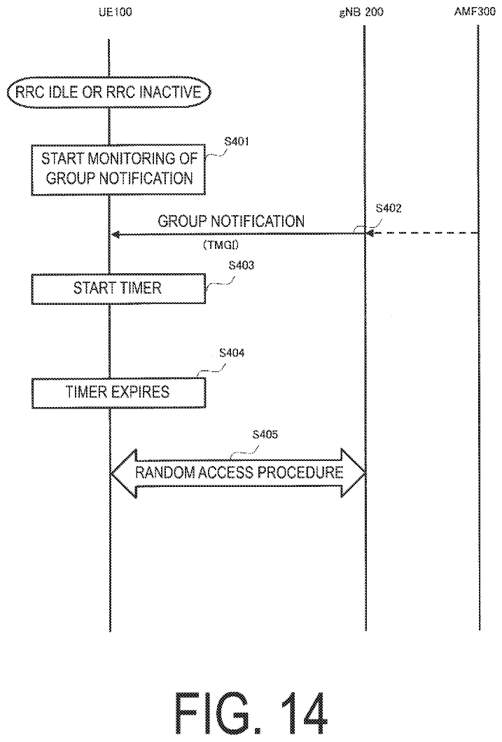

FIG. 14 is a diagram illustrating the second pattern of operation initiated by the UE 100 in the mobile communication system according to an embodiment. Description is given mainly of differences from the patterns of operation described above.

In an initial state of FIG. 14, the UE 100 has already performed the multicast session join process and is in the RRC idle state or the RRC inactive state.

As illustrated in FIG. 14, operations in steps S401 to S402 are the same as and/or similar to the operations in steps S301 to S302.

In step S403, the UE 100 starts the timer (standby timer) in response to receiving the group notification. A timer value of the standby timer is configured from the gNB 200 or the AMF 300. The timer value is individually configured for the UE 100. Note that, when the UE 100 belongs to a subgroup (that is, when the above-described UE group division process is performed), the timer value may be configured for each subgroup.

In step S404, the timer expires.

In step S405, the UE 100 performs the random access procedure. Here, the UE 100 may transmit the random access preamble on a PRACH transmission occasion available firstly after the timer expires.

After that, the UE 100 transitions to the RRC connected state through the random access procedure performed in step S405 to receive the multicast data.

Third Pattern of Operation Initiated by UE 100

A description is given of a third pattern of operation initiated by the UE 100 in the mobile communication system according to an embodiment.

In the third pattern of operation initiated by the UE 100, the UE 100 is configured with a probability of transmitting the random access preamble, from the gNB 200 or the AMF 300. When a random number generated by the UE 100 is equal to or greater than the probability, the UE 100 transmits the random access preamble on the PRACH transmission occasion corresponding to the timing of receiving the group notification. When the random number is smaller than the probability, the UE 100 transmits the random access preamble on a next PRACH transmission occasion following the PRACH transmission occasion described above. This allows the transmission timing of the random access preamble to be dispersed among the UEs 100 depending on the probability configured for the UE 100. Thus, the PRACH overloading is suppressed.

In the third pattern, the probability may be set depending on the priority of the UE 100. The probability may be set to be lower as the priority of the UE 100 is higher.

In the third pattern, the UE 100 may be further configured with a scaling factor from the gNB 200 or the AMF 300. The scaling factor is used to reduce the probability. For example, in the first preamble transmission attempt, the UE 100 compares the generated random number with an initial value of the probability (the value set from the network). Then, in the second preamble transmission attempt, the UE 100 compares the generated random number with a value of the probability to which the scaling factor is applied. This can alleviate the problem that there is a UE 100 incapable of transmitting a preamble within a certain period of time.

In the third pattern, the UE 100 may be further configured, from the gNB 200 or the AMF 300, with an upper limit value of the number of times of the random access preamble transmission attempt. When the number of times of the attempt reaches the upper limit value, the UE 100 immediately transmits the preamble. This can eliminate the problem that there is a UE 100 incapable of transmitting a preamble within a certain period of time.

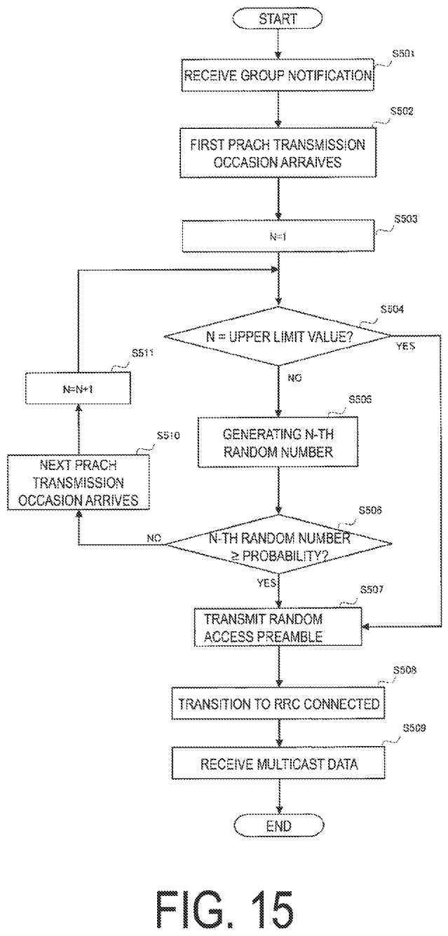

FIG. 15 is a diagram illustrating the third pattern of operation initiated by the UE 100 in the mobile communication system according to an embodiment. Description is given mainly of differences from the patterns of operation described above.

In an initial state of FIG. 15, the UE 100 has already performed the multicast session join process and is in the RRC idle state or the RRC inactive state.

As illustrated in FIG. 15, in step S501, the UE 100 receives the group notification. Here, the group notification includes the identifier (e.g., TMGI) of the multicast session the UE 100 joins.

In step S502, the PRACH transmission occasion arrives that is available firstly after receiving the group notification (the PRACH transmission occasion corresponding to the timing of receiving the group notification).

In step S503, the UE 100 sets the number (N) of times of the random access preamble transmission attempt equal to 1.

In step S504, the UE 100 determines whether the number (N) of times of the attempt reaches the upper limit value. When the number (N) of times of the attempt does not reach the upper limit value (step S504: NO), the UE 100 advances the process to step S505.

In step S505, the UE 100 generates a random number. The random number is a natural number in a range from “0” to “1”.

In step S506, the UE 100 compares the generated random number with the set probability. When the random number is equal to or greater than the probability (step S506: YES), the UE 100 transmits the random access preamble (step S507). That is, in this case, the UE 100 transmits the random access preamble on the first PRACH transmission occasion. After that, in step S508, the UE 100 transitions to the RRC connected state through performing the random access procedure. After that, in step S509, the UE 100 starts to receive the multicast data.

On the other hand, when the random number is smaller than the probability (step S506: NO), the UE 100 advances the process to step S510.

In step S510, the UE 100 determines that the next PRACH transmission occasion arrives, and advances the process to step S511. That is, the UE 100 suspends the transmission of the random access preamble until the next PRACH transmission occasion arrives.

In step S511, the UE 100 increments the number (N) of times of the attempt by 1, and returns the process to step S504. Here, when the number of times of the attempt reaches the upper limit value (step S504: YES), the UE 100 transmits the random access preamble (step S507).

The UE 100 may perform control to lower the probability in the second and subsequent random access preamble transmission attempts. When the UE 100 is configured with the scaling factor, the UE 100 may perform control to lower the probability by using the scaling factor.

A description is given of control patterns 1 to 3 to lower the probability. In the description, assume that the probability configured for the UE 100 is “0.6” and the scaling factor configured for the UE 100 is “0.5”.

Control Pattern 1:

In the control pattern 1, the probability is calculated by the following equation.

Probability(threshold)=[NW-configured probability]/[counter value]

Here, the “Probability (threshold)” represents a probability to be compared in step S506. The [NW-configured probability] represents a probability configured for the UE 100. The [counter value] represents the number (N) of times of the attempt.

In this case, a probability to be compared with the first random number in step S506 is “0.6”. A probability to be compared with the second random number is “0.3” (=0.6/2). A probability to be compared with the third random number is “0.2” (=0.6/3).

Control Pattern 2:

In the control pattern 2, the probability is calculated by the following equation.

Probability(threshold)=[NW-configured probability]/([counter value]×[scaling factor])

In this case, a probability to be compared with the first random number in step S506 is “0.6”. A probability to be compared with the second random number is “0.15” (=0.6/2×0.5). A probability to be compared with the third random number is “0.15” (=0.3×0.5).

Control Pattern 3:

In the control pattern 3, the probability is calculated by the following equation.

Probability (threshold)=[previous probability]/[scaling factor] In this case, a probability to be compared with the first random number in step S506 is “0.6”. A probability to be compared with the second random number is “0.3” (=0.6×0.5). A probability to be compared with the third random number is “0.15” (=0.3×0.5).

Note that although, in each of the above-described control patterns, the UE 100 is assumed to transmit the random access preamble when the random number is equal to or greater than the probability, the UE 100 may be assumed to transmit the random access preamble when the random number is equal to or smaller than the probability. In this case, the probability is calculated by the following equation.

Probability(threshold)=[previous probability]+((1−[previous probability])/[scaling factor])

In this case, a probability to be compared with the first random number is “0.6”. A probability to be compared with the second random number is “0.8” (=0.6+((1−0.6)×0.5)). A probability to be compared with the third random number is “0.9” (=0.8+((1−0.8)×0.5)).

In a fifth pattern of operation initiated by the UE 100, the scaling factor may be used to correct the random number generated by the UE 100. That is, the random number is multiplied by the scaling factor. This can raise the PRACH transmission probability by use of the random number to which the scaling factor is applied even at the same probability.

Fourth Pattern of Operation Initiated by UE 100

A description is given of a fourth pattern of operation initiated by the UE 100 in the mobile communication system according to an embodiment.

In the fourth pattern of operation initiated by the UE 100, the UE 100 transmits the random access preamble on the PRACH transmission occasion determined based on the identifier of the UE 100. This allows the transmission timing of the random access preamble to be dispersed in accordance with the identifier of the UE 100, suppressing the PRACH overloading.

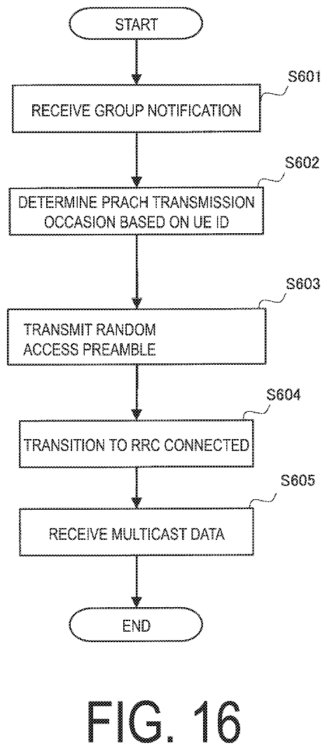

FIG. 16 is a diagram illustrating the fourth pattern of operation initiated by the UE 100 in the mobile communication system according to an embodiment. Description is given mainly of differences from the patterns of operation described above.

In an initial state of FIG. 16, the UE 100 has already performed the multicast session join process and is in the RRC idle state or the RRC inactive state.

As illustrated in FIG. 16, in step S601, the UE 100 receives the group notification. Here, the group notification includes the identifier (e.g., TMGI) of the multicast session the UE 100 joins.

In step S602, the UE 100 determines a PRACH transmission occasion on which the random access preamble is to be transmitted, based on the identifier of the UE 100 itself. To be specific, the UE 100 determines a PRACH transmission occasion that meets a condition expressed by the following equation as the PRACH transmission occasion on which the random access preamble is to be transmitted.

UE-ID mod M=[PRACH occasion count](or SFN)mod M

### Here, the “UE-ID” is a 5G-S-TMSI or an I-RNTI.

The “PRACH occasion count” is a count value for each PRACH transmission occasion. When only one PRACH transmission occasion is provided for one frame, the “PRACH occasion count” is a System Frame Number (SFN).

“M” represents the period. “M” is configured for the UE 100 by the gNB 200 or the AMF 300. “M” is determined by one of the following methods.
1) “M” is determined based on the QoS of the multicast service (e.g., access delay tolerance). In this case, M is determined to be larger as the access delay tolerance is larger, and “M” is determined to be smaller as the access delay tolerance is smaller.
2) “M” is determined based on a capacity of the PRACH resource (or an influence degree on a unicast service). In this case, “M” is determined to be larger as the capacity (or the influence degree) is larger, and “M” is determined to be smaller as the capacity (or the influence degree) is smaller.

According to the above equation, the transmission timing of the random access preamble is dispersed in accordance with the identifier of the UE 100.

In step S603, the UE 100 transmits the random access preamble on the PRACH transmission occasion determined in step S602. After that, in step S604, the UE 100 transitions to the RRC connected state through performing the random access procedure. After that, in step S605, the UE 100 starts to receive the multicast data.

In the fourth pattern of operation initiated by the UE 100, the subgroup identifier in the pattern of operation initiated by the gNB 200 described above may be used instead of the identifier of the UE 100. In this case, the identifier (or UE-ID) of the UE 100 may be interpreted as the subgroup identifier.

Fifth Pattern of Operation Initiated by UE 100

A description is given of a fifth pattern of operation initiated by the UE 100 in the mobile communication system according to an embodiment.

In the fifth pattern of operation initiated by the UE 100, the UE 100 is configured with at least one process selected from the group consisting of the processes of the second to fourth patterns describe above.

In the fifth pattern, the RRC layer of the UE 100 notifies the NAS layer of the UE 100 that the group notification is received. The NAS layer notifies the RRC layer of access information indicating an access class or an access identifier. When the access information matches specific access information, the UE 100 transmits the random access preamble on the first PRACH transmission occasion after the timing of receiving the group notification (the PRACH transmission occasion corresponding to the timing of receiving the group notification).

When the access information does not match the specific access information, the UE 100 performs the at least one process.

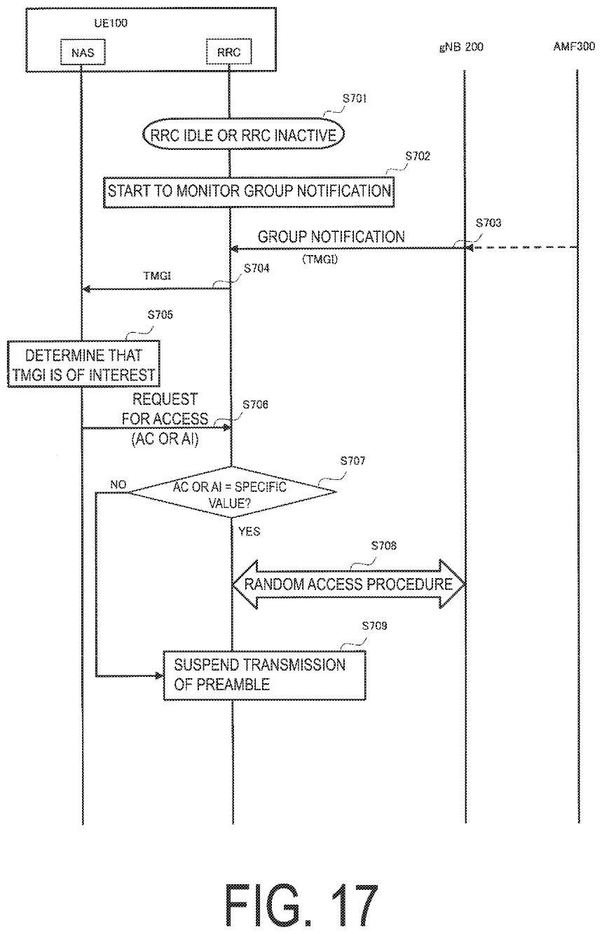

FIG. 17 is a diagram illustrating the fifth pattern of operation initiated by the UE 100 in the mobile communication system according to an embodiment. Description is given mainly of differences from the patterns of operation described above.

In step S701, the UE 100 (RRC layer) is in the RRC idle state or the RRC inactive state.

In step S702, the UE 100 (RRC layer) starts monitoring of the group notification from the gNB 200.

In step S703, for the UE 100 (RRC layer) receives the group notification from the gNB 200. Here, the group notification includes the identifier (e.g., TMGI) of the multicast session.

In step S704, the RRC layer of the UE 100 notifies the NAS layer of the UE 100 of the identifier of the multicast session notified in step S703.

In step S705, the NAS layer of the UE 100 determines whether to be interested in the multicast session corresponding to the notified identifier. When determining to be interested in the multicast session, the NAS layer makes a request to the RRC layer for an access to the gNB 200 in step S706. In accordance with the request, the NAS layer notifies the RRC layer of an Access Class (AC) and/or an Access Identity (AI). Note that the AC and/or the AI may be determined depending on the access priority of the UE 100. The access priority of the UE 100 may be determined by the “process related to the priority of the UE 100” described above.

In step S707, the RRC layer determines whether the notified AC and/or AI has a specific value (specific access information). The specific value may be notified (set) by the gNB 200. The specific value may be hard coding (a value determined by a specification). When the AC and/or the AI has the specific value (step S707: YES), in step S708, the UE 100 performs the random access procedure with the gNB 200. To be more specific, the UE 100 transmits the random access preamble on the first PRACH transmission occasion after the timing of receiving the group notification.

On the other hand, when neither the AC nor the AI has the specific value (step S707: NO), in step S709, the UE 100 suspends the transmission of the random access preamble. Thereafter, the UE 100 performs at least one selected from the group consisting of the processes of the second to fourth patterns described above configured for the UE 100 itself. For example, when the standby timer of the second pattern is configured for the UE 100, the UE 100 starts the standby timer. When the probability of the third pattern is configured for the UE 100, the UE 100 generates a random number and compares the random number with the probability.

Sixth Pattern of Operation Initiated by UE 100

A description is given of a sixth pattern of operation initiated by the UE 100 in the mobile communication system according to an embodiment.

In the sixth pattern of operation initiated by the UE 100, the UE 100 is allocated a PRACH transmission occasion from the gNB 200. After receiving the group notification, the UE 100 transmits the random access preamble on the PRACH transmission occasion.

In the sixth pattern, firstly, the gNB 200 notifies the UE 100 of the PRACH transmission occasion allocated to the UE 100 by use of the SIB or the RRC Release message. Secondly, the UE 100 receives the group notification from the gNB 200. Thirdly, the UE 100 transmits the random access preamble on the PRACH transmission occasion allocated to the UE 100 itself.

Note that, when the UE 100 has a high access priority for the multicast session, even when the UE 100 is configured to perform at least one selected from the group consisting of the first to sixth patterns described above, the UE 100 may ignore these configurations and transmit the random access preamble on the PRACH transmission occasion that is available firstly in response to receiving the group notification.

### OTHER EMBODIMENTS

The operation patterns described above can be separately and independently implemented, and also be implemented in combination of two or more of the operation patterns. For example, some of the steps in one pattern of operation may be added to another pattern of operation. Some of the steps in one pattern of operation may be replaced with some of the steps in another pattern of operation.

In the embodiment described above, an example in which the base station is an NR base station (i.e., a gNB) is described; however, the base station may be an LTE base station (i.e., an eNB). The base station may be a relay node such as an Integrated Access and Backhaul (IAB) node. The base station may be a Distributed Unit (DU) of the IAB node.

A program causing a computer to execute each of the processes performed by the UE 100 or the gNB 200 may be provided. The program may be recorded in a computer readable medium. Use of the computer readable medium enables the program to be installed on a computer. Here, the computer readable medium on which the program is recorded may be a non-transitory recording medium. The non-transitory recording medium is not particularly limited, and may be, for example, a recording medium such as a CD-ROM or a DVD-ROM.

Circuits for performing the processes performed by the UE 100 or the gNB 200 may be integrated to configure at least a portion of the UE 100 or the gNB 200 as a semiconductor integrated circuit (chip set, System on a Chip (SoC)).

The phrases “based on” and “depending on” used in the present disclosure do not mean “based only on” and “only depending on,” unless specifically stated otherwise. The phrase “based on” means both “based only on” and “based at least in part on.” The phrase “depending on” means both “only depending on” and “at least partially depending on.” The term “obtain/acquire” may mean “obtain/acquire information from stored information,” “obtain/acquire information from information received from another node,” or “obtain/acquire information by generating the information.” The terms “include,” “comprise,” and variations thereof do not mean “include only items stated” but instead mean “may include only items stated” or “may include not only the items stated but also other items.” The term “or” used in the present disclosure is not intended to be “exclusive or.” Furthermore, any references to elements using designations such as “first” and “second” as used in the present disclosure do not generally limit the quantity or order of those elements. These designations may be used herein as a convenient method of distinguishing between two or more elements. Thus, a reference to first and second elements does not mean that only two elements may be employed there or that the first element needs to precede the second element in some manner. For example, when the English articles such as “a,” “an,” and “the” are added in the present disclosure through translation, these articles include the plural unless clearly indicated otherwise in context.

Embodiments have been described above in detail with reference to the drawings, but specific configurations are not limited to those described above, and various design variation can be made without departing from the gist of the present disclosure.

Supplementary Note

### Introduction

In RAN #88, revised work items were approved that are related to NR multicast broadcast service (MBS). The group notification was discussed in RAN2 #113bis-e and the following agreements were achieved.
To support the multicast group notification of the MBS supporting nodes.
For the delivery mode 1, the UE is not scheduled to monitor the group notification channel in the RRC connected state.
Whether RAN2 needs to handle the PRACH capacity issues due to group notification needs to be discussed further.
To use the same group notification ID for both the RRC idle state and the RRC inactive state.

### Reply LS:

For non-supporting nodes, the use of the MBS session ID does not work to affect the non-MBS nodes. The unicast paging works.
The MBS session ID can be used to support the node.
Short post e-mail discussion for LS reply.

In this supplementary note, details of the group notification and the PRACH capacity issues are described.

### Discussion

### Group Notification in Delivery Mode 1

According to SA2 LS, the group notification is used for activation of the multicast session. RAN2 agreed on that the group notification based on the MBS session ID can be performed at the NG-RAN node supporting MBS and that the same group notification ID is used for the UE in both the idle and inactive states.

Observation 1: The group notification based on the MBS session ID is transmitted to the UE in the idle/inactive states by the gNB supporting the MBS, through activation of the multicast session.

In an e-mail discussion, two options for the group notification were defined.

Option 1: Paging-based group notification.
Option 2: MCCH-based group notification.

Option 1 is very simple because the UE in the idle/inactive states needs to monitor paging as legacy, i.e., needs to monitor the unicast regardless of interest in the multicast reception. Furthermore, the power consumption of the UE to receive the group notification may be possible to be minimized (which will be discussed later).

Option 2 is a possible solution because the MCCH is introduced for the multicast reception of the UE in the idle/inactive states in addition to the connected state. Note that, since the MCCH is agreed to be introduced only in delivery mode 2, the use of the MCCH in delivery mode 1 is a little strange. Delivery modes 1 and 2 need to maintain maximum commonality in terms of, for example, using MTCH, a common IE for configuration, etc., but the procedures need to be independent as much as possible.

Therefore, RAN2 needs to agree on that the group notification reuses existing paging mechanism.

Proposal 1: RAN2 needs to agree on that existing paging mechanism is reused for the group notification.

When Proposal 1 can be agreed upon, how to integrate the group notification with existing paging needs to be discussed. The current paging message includes a paging record list which is a list of the UE IDs to be paged, i.e., the 5G-S-TMSIs or the I-RNTIs. For the paging-based group notification, the following two options are considered.

Option A: The MBS session ID is listed in an existing paging record list.

Option B: The MBS session ID is displayed in a new record list.

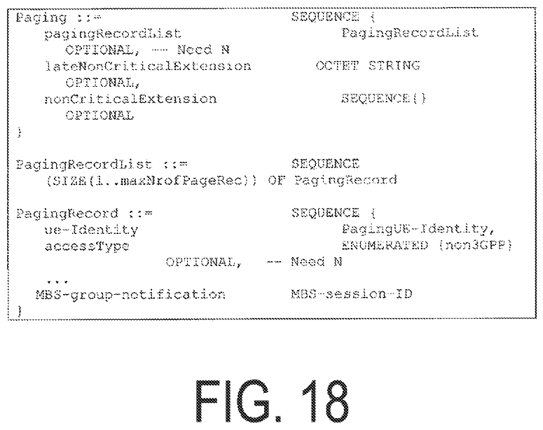

Option A may be technically feasible as illustrated in FIG. 18, but the unicast UE ID and the MBS session ID need to be allowed to coexist in the same record. Since the UE ID cannot be deleted from the paging record unless there is backward compatibility, the unicast UE ID and the MBS session ID need to be allowed to coexist in the same record. Although, as another sub-option, a discussion may be made on adding the MBS session ID in the paging UE ID, this is a little strange since the MBS session ID is not a UE ID.

That is, the MBS session ID is a concept different from the 5G-S-TMSI or the I-RNTI.

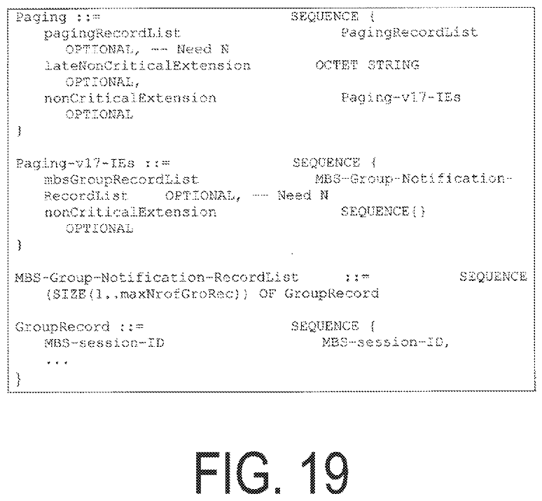

As illustrated in FIG. 19, Option B is feasible and simple. There is no conflict with the existing IE concept. There is also no possibility of affecting the legacy UEs.

Therefore, the RAN2 needs to agree to define a new record list, that is Option B, in the paging message.

Proposal 2: The RAN2 needs to agree to define a new record list of group notifications in the existing paging message.

There are some discussions as to whether the group notification and the unicast paging are received simultaneously. From the UE perspective, the additional power consumption for reception of the group notification needs to be minimized. In particular, the group paging is for the UE in the idle/inactive states. When Proposal 2 can be agreed on, the UE receives the paging message on the PF/PO as in the legacy. Thus, whether the UE is interested in the multicast reception is irrelevant. That is, the UE interested in the multicast reception can check the group notification without additional wake-up.

Observation 2: From the UE perspective, the additional wake-up occasion affects the UE's power consumption.

To achieve this, the gNB may need to repeatedly transmit the group notification during one paging DRX cycle (e.g., 320 ms) to ensure that all UEs receive the paging message. From the NW perspective, there may be concerns about the paging capacity. Note that the group paging is integrated into the existing paging message, leading no problem in practice. That is, the group notification can be transmitted on any paging of any UE and any unicast MT access. For example, even when the paging resources are loaded, some UEs have paging and the group notification is piggybacked as in Proposal 2. With no MT access, i.e., no unicast paging transmission, the paging resource is not loaded, so the paging can only be transmitted for the group notification.

Observation 3: From the NW perspective, the group notification repeated during one paging cycle little affects the paging resource load.

Proposal 3: The RAN2 needs to agree on that the UE monitors only the existing PF/PO to receive the group notification. That is, no additional wake-up time is required.

PRACH Capacity Issue:

Further study is needed for the PRACH capacity issue. Due to the group notification, many UEs are simultaneously paged and many PRACH collisions occur. Therefore, access delay may occur regardless of a multicast service or a unicast service.

Option I: Depend on gNB Implementation.

Depending on the implementation, the gNB can always prepare more resources before the start of the multicast session. This may be particularly necessary for high QoS services.

Note that, in order to change the PRACH resource, the SIB needs to be changed. This may cause a problem when many multicast sessions are activated in a short time.

Option II: Introduce a Mechanism to Spread the PRACH Transmission.

Even when some UEs start a PRACH transmission and other UEs receive a group notification at the same time, this problem can be solved when such other UEs need to wait for it. Several possible mechanisms are considered, such as wait timer, RAND-based hash, UE ID-based hash, TMGI (or MBS session ID) subgrouping, etc. A disadvantage is that additional standardization work is required.

The PRACH capacity is certainly an issue for the group notification in delivery mode 1. Therefore, the RAN2 needs to discuss how to solve the issue, such as the above options and other methods.

Proposal 4: The RAN2 needs to discuss how to solve the PRACH capability issue, for example, by the gNB implementation or the new standard mechanism.

1. A communication control method used in a mobile communication system for providing a multicast broadcast service (MBS), the communication control method comprising:
transmitting, by a network node to a group comprising a plurality of user equipments, a group notification indicating activation of a multicast session corresponding to the group; and
receiving, by the network node, a random access preamble transmitted from the user equipment in response to reception of the group notification.

2. The communication control method according to claim 1, wherein
the transmitting of the group notification comprises transmitting, by the network node, the group notification to each of a plurality of subgroups at different timings, the plurality of subgroups being obtained by dividing the group.

3. The communication control method according to claim 2, further comprising:
acquiring, by a network apparatus, priorities of the plurality of user equipments belonging to the group; and
dividing, by the network apparatus, the group based on the priorities, wherein
the transmitting of the group notification comprises transmitting the group notification to a subgroup to which a user equipment having a first priority belongs, and then transmitting the group notification to a subgroup to which a user equipment having a second priority belongs, the second priority being lower than the first priority, and
the network apparatus is the network node or a core network apparatus.

4. A user equipment supporting multicast/broadcast services (MBS), the user equipment comprising:
a receiver configured to receive from a network, a group notification transmitted to a group comprising a plurality of user equipments, the group notification indicating activation of a multicast session corresponding to the group, and
a transmitter configured to transmit to the network node, a random access preamble in response to reception of the group notification.

5. A network node configured to provide multicast/broadcast services (MBS), the network node comprising:
a transmitter configured to transmit to a group comprising a plurality of user equipments, a group notification indicating activation of a multicast session corresponding to the group, and
a receiver configured to receive a random access preamble transmitted from the user equipment in response to reception of the group notification.
